(19) United States
(12) Patent Application Publication
(10) Pub. No.: US 2008/0130900 A1
(43) Pub. Date: Jun. 5, 2008

(54) Method and apparatus for providing secure communication

(76) Inventor: Vincent W. Hsieh, Cupertino, CA (US)

Correspondence Address: JEFFREY HALL, 212 CLINTON ST, SANTA CRUZ, CA, 95062, US

(21) Appl. No.: 12/005,567

(22) Filed: Dec. 27, 2007

Related U.S. Application Data
(63) Continuation-in-part of application No. 10/783,229, filed on Feb. 20, 2004, now abandoned.
(60) Provisional application No. 60/512,948, filed on Oct. 20, 2003.

(51) Int. Cl. H04L 9/00; H04L 9/08; G06F 21/00

(52) U.S. Cl. 380/278; 726/3; 726/11

(57) ABSTRACT

A method for providing secure communication in a computer system or network is disclosed where two or more clients, connect by firewalls and/or network address translation devices where no direct connection is possible, communicate via a proxy communication server using secure message transmission protocols such as the Secure Socket layer (SSL). Public-Private Key Exchange and secured data transfer are brokered by the proxy communication server as if the two clients are connected via the network directly without the need of decrypting the data and protocol communication traffic. The method provides enhanced security as no encryption key is disclosed on the proxy side and no data is transmitted or stored on the proxy unencrypted and improved performance is achieved as no data encryption or decryption is required by the proxy, and reduces network management requirements.

### CROSS REFERENCE TO RELATED APPLICATIONS

This application is a continuation-in-part of and claims priority from co-pending U.S. patent application Ser. No. 10/783,229, filed Feb. 20, 2004, which is related to and claims priority from U.S. Provisional Patent Application 60/512,948, filed Oct. 20, 2003.

### BACKGROUND OF THE INVENTION

1. Field of Invention

The present invention relates to a secure communication methodology and an approach for establishing secured “proxy” communication sessions between two or more clients allowing them to communicate via a communication “proxy” server. In particular, the present invention relates to a secure communication method that can operate in the restricted network environments where one or more clients are behind NAT devices and direct network connection is not possible between the clients; and provides end-to-end Secure Socket Layer (SSL) communication between the clients via a proxy communication server, using one or more protocols, using one or multiple communication ports.

2. Description of the Related Art

Network Address Translation (NAT) devices such as gateway and routers, connect many of the computers inside the corporate and home networks to the Internet and block direct access by computers from the Internet to computers on the internal network.

Network Address Translation is a technique of receiving network traffic through a router that involves re-writing the source and/or destination IP addresses and usually also the TCP/UDP port numbers of IP packets as they pass through. Most systems using NAT do so in order to enable multiple hosts on a private network to access the Internet using a single public IP address.

NAT first became popular as a way to deal with the IPv4 address shortage and to avoid all the difficulty of reserving IP addresses. NAT has proven particularly popular in countries, which have fewer address-blocks allocated per capita. It has become a standard feature in routers for home and small-office Internet connections. NAT also adds to security as it disguises the internal network's structure: all traffic appears to outside parties as if it originates from the gateway machine. To a system on the Internet, the router itself appears to be the source/destination for this traffic.

Hosts behind NAT-enabled routers do not have true end-to-end connectivity and cannot participate in some Internet protocols. Services that require the initiation of TCP connections from the outside network, or stateless protocols such as those using UDP, can be disrupted.

Unless the NAT router makes a specific effort to support such protocols, incoming packets cannot reach their destination. Some protocols can accommodate one instance of NAT between participating hosts (“passive mode” FTP, for example), sometimes with the assistance of an Application Layer Gateway, but fail when both systems are separated from the Internet by NAT.

End-to-end connectivity has been a core principle of the Internet, supported for example by the Internet Architecture Board. Current Internet architectural documents observe that NAT is a violation of the End-to-End Principle, but that NAT does have a valid role in careful design.

In the absence of end-to-end connectivity and direct computer to computer access, Internet applications rely on the use of relay servers, run on private or public computers, to deliver data among Internet hosts. Instant Messenger/Chat and Peer-to-Peer file sharing are just a few among those examples.

There are, however, fraudulent computers on the Internet that collect personal, financial, or copyrighted data for unwarranted use. In addition, as information being routed via various network relay/proxy servers, it may be tempered or altered during delivery.

To combat these intruders, most communication protocols now implement some form of communication security, which ranges from simple scrambling to very sophisticated encryption algorithms. More particularly, the Transmission Control Protocol (TCP)/Internet Protocol (IP) used by many networks, including the Internet, was adapted to include security protocols such as Secure Socket Layer (SSL). The following is a brief description of the SSL protocol.

SSL is a protocol developed for the transmission of private data (e.g., a text document) via the Internet. SSL provides a secure connection to communicate data between a client and a server by using a private key to encrypt the data. Private key/public key encryption is well understood and frequently implemented by modem computer networks to ensure privacy of information being transmitted from a sender computer to a recipient computer. Web browsers, such as Netscape Navigator and Internet Explorer, support SSL, and many Web sites implement the SSL protocol to obtain confidential user information, such as credit card numbers. SSL provides the mechanism to implement authentication and encryption. Authentication ensures that each of the client and server is who it claims to be. In practice, authentication may simply involve entering a user identification (ID) and password. However, a computer hacker may eavesdrop on the client-server link to intercept password and user name information. Encryption deters such mischief by scrambling the user ID and password information before transmission over the network. In addition to encrypting user information, SSL uses encryption to secure nearly every type of data including the payload (i.e., a text document) communicated between the client and server. In effect, SSL provides for encryption of a session, and authentication of a server, message, and optionally a client. For further details on the SSL protocol, reference is made to SSL Protocol Specification, versions 2 and 3, which are incorporated by reference.

SSL is a protocol that protects any level protocol built on protocol sockets, such as telnet, file transfer protocol (FTP), or hypertext transfer protocol (HTTP). As is known in the network technology, a socket is a software object that connects an application to a network protocol. For example, in UNIX, a program sends and receives TCP/IP messages by opening a socket and reading and writing data to and from the socket. This simplifies program development because the programmer need only worry about manipulating the socket and may rely on the operating system to actually transport messages across the network correctly. Many of the functions provided by SSL are part of a next generation IP protocol (IPng) known as IP version 6 (IPv6), being considered by Internet Engineering Task Force (IETF), which is the main standards organization for the Internet.

The referenced application describes a proxy communication server (CS) configured to manage client communications and relay data traffic in a communication network. When a communication network involves connecting clients behind NAT devices, management of client transactions requires adaptation to and compliance with the NAT device operations.

In a network configuration where client A and Client B are both behind NAT devices, client A needs to communicate with client B with the assistance of a relay server (RS). In the above example, Client A can't directly connect to Client B and vice versa (A->B, B->A). CS can't directly connect to Client A or Client B (CS->A, CS->B). The only direct connections possible are from Client A to CS and from Client B to CS (A->CS, B->CS).

The need to connect A and B over CS is accomplished by 1) A connect to CS (A->CS), 2) B connect to CS (B->CS), and 3) relay traffic between A and B mediated by CS (A->CS->B, B->CS->A).

Although modern Internet application such as Internet Relay Chat (IRC) and P2P do not secure their proxy connection, using conventional security, it is possible to provide enhanced security. For example, it is possible to secure the connection (A->CS) using encryption key K1 and secure (B->CS) using encryption key K2. In order for B to receive the correct data, when data travel from A->CS->B, one needs to encrypt data on A using key K1, decrypt data using key K1 on CS, re-encrypt the data using key K2 on CS, and when the data arrive at B, decrypt the data using key K2. The data is protected during transmission from A->CS and from CS->B. However, the data is without protection when it is (decrypted) on the CS. Furthermore, since CS has access to both K1 and K2, security may be compromised.

It is important to recognize that, traditional security such as SSL Proxy, designed to enhance SSL acceleration by load balancing SSL traffic among multiple SSL proxy servers, does not work this network configuration and does not address the stated deficiencies. SSL Proxy design has the following feature and limitations:

It is designed to secure communication traffic from the access client to the SSL Proxy server. SSL Proxy is a uni-directional system solution. SSL Proxy connects client to server, not server to client. SSL Proxy may not provide encryption beyond the Proxy server—from the Proxy server to the destination.

SSL Proxy may not operate when both clients are behind NAT devices. SSL Proxy requires direct connection proxy server to the destination to operate. For the above reasons stated, when the target server is behind NAT device, the Proxy server can't make connection to the target server and the Proxy system does not operate.

The need to provide enhance security so the deficiencies mentioned above may be eliminated is particularly important when CS is an Internet computer, and especially, when CS is a public server.

Therefore, there is a need in the network communication technology, such as the Internet, to support brokering of client transactions over secure (e.g., SSL) communication networks without the above concerns and limitations. The present invention eliminates proxy security deficiencies during secure SSL transactions mediated by a proxy communication server.

### BRIEF SUMMARY OF THE INVENTION

A method is provided herein for establishing secured communication, in a computer system or network where, behind NAT devices, two or more clients communicate via a communication server. The method preferably uses a secure communication protocol such as SSL via a single communication port such as SSL port 443, or in other embodiments multiple ports may be utilized.

The present method allows for an improved means for establishing secured communication, where, two or more clients communicate via a communication server, end-to-end secure protocol such as SSL is realized using a “Secure Proxy” method.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a schematic view of an Internet connection without NAT devices.

FIG. 2 shows a schematic view of an Internet connection with NAT devices where direct connections between clients behind NAT devices may not be possible due to NAT device restrictions.

FIG. 3 shows a schematic view of prior methodology of using a relay server to facilitate communication between clients behind NAT devices.

FIG. 4 shows a schematic view of prior methodology of a relay server using conventional methods to facilitate enhanced secure communication between clients behind NAT devices.

FIG. 5 shows a preferred methodology of the present invention in comparison to prior methodology shown in FIG. 4, where, in FIG. 5, the “Secure Proxy” protocol using SSL is illustrated, according to the invention, to facilitate enhanced secure communication between clients behind NAT devices, according to the invention.

FIG. 6 is a flow chart illustrating the preferred method of establishing secure communications, according to the invention.

FIG. 7 is a flow chart illustrating the preferred method of establishing secure communications when both clients are behind NAT devices, according to the invention.

FIG. 8 is a flow chart illustrating the preferred handshake sequence in authentication of clients while establishing a secure communication channel between the clients via the communication server, according to the invention.

FIG. 9 is a flow chart illustrating the preferred handshake sequence in authentication of clients when both clients are behind NAT devices, according to the invention.

### DETAILED DESCRIPTION OF THE INVENTION

Reference will now be made in detail to the present preferred embodiments of the invention as illustrated in the accompanying drawings.

In accordance with the invention an improved method for establishing secured communication is provided, where, two or more clients communicate via a communication server using a “Secure Proxy” protocol that allows secure communication with end-to-end network security from the access client to the target client.

As used herein and in the figures, a client(s) is defined as any computing device, or device with the ability to store a computer program, computer program, or user of such device or program.

The present method provides an improved means for establishing secured communication, where, two or more clients communicate via a communication server (CS) using the “Secure Proxy” protocol communication described herein, the “Secure Proxy” component resides on the clients, as well as the communication server. Connection can be made from any of the clients to the communication server, given the limitations of the NAT devices and the fact that clients may be behind NAT devices, the clients may not make connection to one another, and that the communication server may not be able to make connection to any of the clients.

The present method provides an improved means for establishing secured communication, where, two or more clients communicate via a communication server using the “Secure Proxy” protocol communication described herein, that allows access from behind a NAT device to any location, behind a NAT device, and without the need to disclose encryption key or the need to expose unencrypted data on the communication server.

The term “relay server” is used to denote Internet relay server. Examples of these “network relay” servers are: Peer to Peer (P2P) File Sharing Server and Internet Chat Relay (IRC) Server. To distinguish it from the terms used in the invention—“Secure Proxy” protocol, the term “communication server” is used instead.

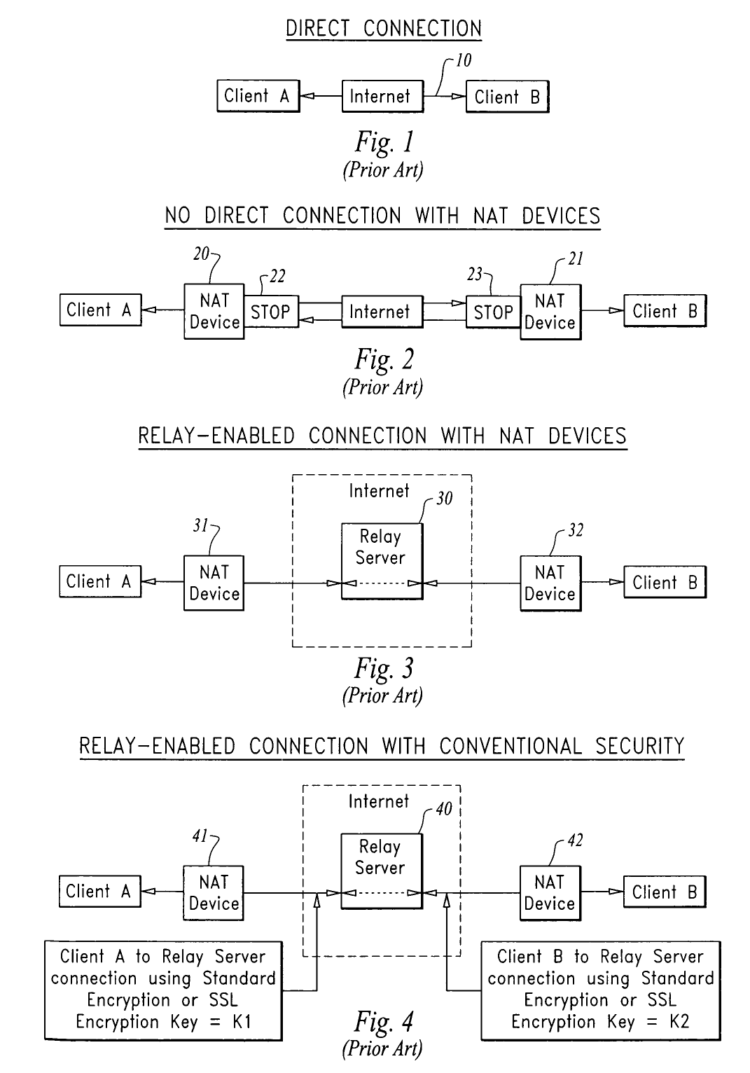

In FIG. 1, a direct network connection 10, over the Internet is illustrated. FIG. 2, shows a comparative illustration of using NAT devices 20 and 21 to connect computers to the Internet. Limited by the NAT device restrictions, direct connection between the clients is prohibited 22 and 23.

With reference to FIG. 3, a prior methodology of using relay server (RS) 30 to facilitate communication between clients behind NAT is shown. In general, NAT devices permit outbound connections (A->RS) (B->RS) while disallowing all inbound connections (A<-B, B<-A, A<-RS, B<-RS). Communication between Client A and Client B is facilitate by the relay server RS where, Client A connects to the relay server (A->CS), Client B connects to the relay server (B->RS), and RS relays data transfers between A and B. All data transfer are in clear, no encryption/security is enforced.

With reference now to FIG. 4, an example of prior methodology is shown using a relay server where conventional methods to provide secure communication between clients behind NAT devices is used. In FIG. 4 relay server (RS) 40 uses conventional security methods to facilitate enhanced secure communication between clients behind NAT devices 41 and 42.

In FIG. 4, data transfers between client A->RS and client B->RS are encrypted. Data transfer between client A and the RS is encrypted using encryption key K1, 43. Data transfer between client B and the RS is encrypted using encryption key K2, 44. The method of security may be either simple encryption or SSL. The data is first encrypted by client A using K1, transferred to the RS, decrypted by the RS using K1 and then re-encrypted with the encryption key K2 held and recognized by the target client before being relayed to client B. Note that, RS has in its possession both encryption keys K1 and K2, therefore, RS is capable of (decrypting and) accessing all data transferred between client A and Client B, unencrypted.

In the following description, a single (one) communication port, such as the SSL TCP/IP port 443, is used, for all of the communications. To simplify discussions, the SSL port 443 will be used in the following. However, it is understood that using the method of the present invention, other single ports may be used, as well as multiple ports, however, the preferred port is SSL port 443.

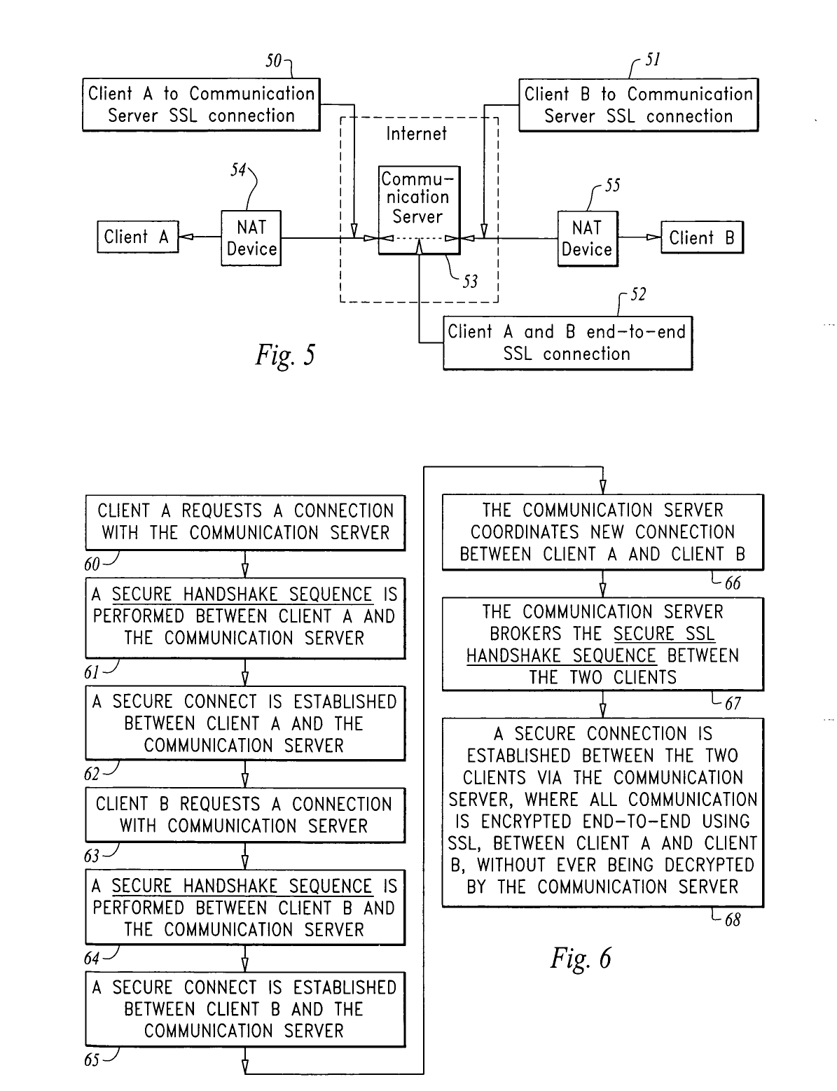

As seen in FIG. 5, the methodology of the present invention in comparison to prior methodology shown in FIG. 4 is shown, where in FIG. 5 the “Secure Proxy” protocol using SSL is illustrated, according to the invention, to facilitate enhanced secure communication between clients behind NAT devices. Between client A and client B, both behind NAT devices, end-to-end SSL secure Private-public key exchange sequence 52, and data connection are relayed by communication server 53. End-to-end security is maintained, since 1) No encryption key that is used to encrypt/decrypt data between client A and client B is disclosed, or accessible by the communication server. 2) The communication server is not capable of access any data transferred between client A and Client B, unencrypted.

In FIG. 6, one of the clients, client A makes a connection request to the communication server. This is also seen in FIG. 8. Preferably, the communication server, 69: Listens on port 443 for requests, using a function, such as the Socket Listen ( ) function. The client connection requests 60, preferably comprises receiving a connection request from the client and the communication server accepts the connection. A network protocol handshake 61, such as SSL handshake Private-Public Key Exchange (for the convenience of discussion, in the future, SSL handshake Private-Public Key Exchange will be referred to simply as SSL handshake), may be performed between the client and the communication server. A secure network connection 62, is established between the client and the communication server.

Another of the clients, client B, makes a connection request to the communication server. Preferably, the Communication server (CS): Listens on port 443 for requests, using a function, such as the Socket Listen ( ) function. The client connection requests 63, preferably comprises receiving a connection request from the client and the communication server accepts the connection. A network protocol handshake 64, such as SSL handshake, may be performed between the client and the communication server. A secure network connection 65, is established between the client and the communication server.

Connection requests of one client to the other, preferably comprise: the communication server looks up the client information, and either allows or denies the connection based on the client authorization information. The communication server coordinates 66, with both clients, to start a new network protocol handshake, such as the SSL handshake.

While the communication server will not respond to, nor start new secure connection handshake sequence 67, such as SSL, with either client, it relays (proxies) the data communications exchange between the two clients. Thus the two clients form a secure connection, such as SSL, between themselves. The two clients may then communicate securely over this “Secure Proxy” connection 68.

Client information exchange 66, coordinated by the communication server, is preferably provided by the client information being passed to the communication server, such as system name/ID, and network address. The communication server may then use this information to identify this client, provide transparent access from others to this client, and to provide access control. This exchange may take place in different ways, at different times, by the choices of the client of the protocol, it may also be omitted.

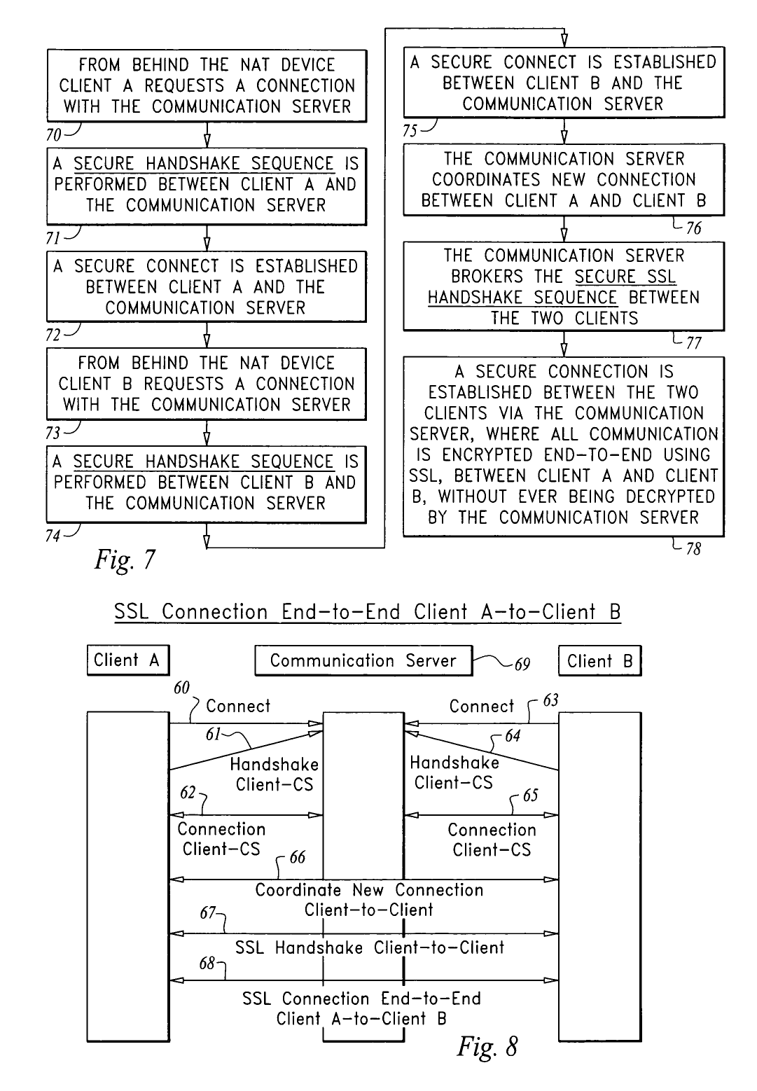

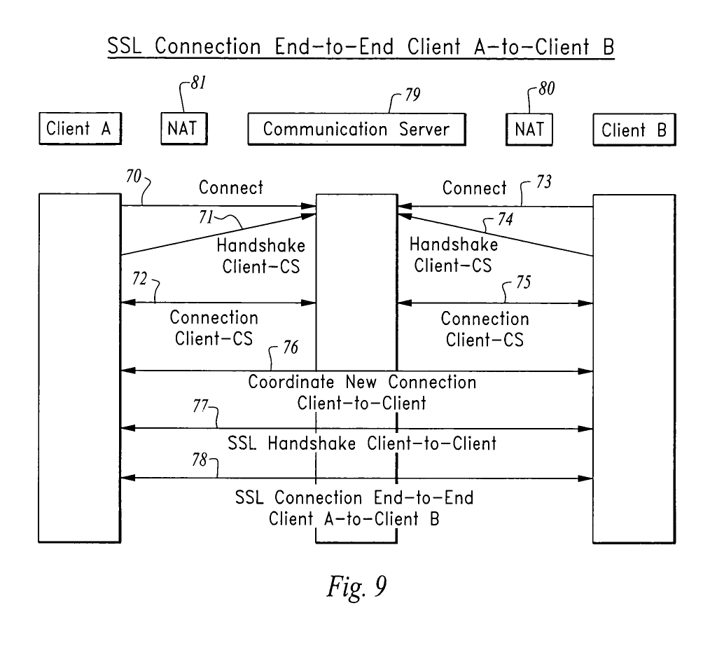

In FIG. 7, where NAT device are present: One of the clients, client A makes a connection request to the communication server. This is also seen in FIG. 9, where clients A and B are behind NAT devices 81 and 80 respectively.

With reference to FIG. 7, preferably, the communication server 79, listens on port 443 for requests, using a function, such as the Socket Listen ( ) function. The client connection requests 70, preferably comprise receiving a connection request from the client behind NAT device 80, seen in FIG. 9, and the communication server accepts the connection. A network protocol handshake 71, such as SSL handshake Private-Public Key Exchange (for the convenience of discussion, in the future, SSL handshake Private-Public Key Exchange will be referred to simply as SSL handshake), may be performed between the client and the communication server. A secure network connection 72, is established between the client and the communication server.

Another of the clients, client B preferably makes a connection request to the communication server. Preferably, the communication server 79, seen in FIG. 9, listens on port 443 for requests, using a function, such as the Socket Listen 0 function. The client connection requests 73 preferably comprise receiving a connection request from the client behind NAT device 80 and the communication server accepts the connection. A network protocol handshake 74, such as SSL handshake, may be performed between the client and the communication server. A secure network connection 75, is established between the client and the Communication server.

Connection requests of one client to the other, preferably comprise: the communication server looks up the client information, and either allows or denies the connection based on the client authorization information. The communication server coordinates 76, with both clients, to start a new network protocol handshake, such as the SSL handshake.

While the communication server will not respond to, nor start new secure connection handshake sequence 77, such as SSL, with either client, it relays (proxies) the data communications exchange between the two clients. Thus the two clients form a secure connection, such as SSL, between themselves. The two clients may then communicate securely over this “Secure Proxy” connection 78.

Client information exchange 76, coordinated by the communication server, is preferably provided by the client information being passed to the communication server, such as system name/ID, and network address. The communication server may then use this information to identify this client, provide transparent access from others to this client, and to provide access control. This exchange may take place in different ways, at different times, by the choices of the client of the protocol, it may also be omitted.

Using the “Secure Proxy” protocol as herein described, either with a single port or multiple ports, allows for a secure communication between two or more clients communicating via a communication server to be established. Such communication is secure in the computer system or network and internet communications. Several possible forms of communication sessions may be established. For example, a one-to-one communication session where one client communicates with another client via a communication server or a one-to-many communication session where one client communicates with two or more other clients via a communication server, or a many-to-many communication session where two or more clients communicate with two or more other clients via a communication server are possible

In operation and use the present invention provides end-to-end network security. This end-to-end security allows enhanced network security from client to communication server, communication server to (target) client, and client to client communications using a secure network protocol such as SSL.

The present methodology provides an improved method for establishing secured communication, where, no direct network access from one client to the other is allowed such as behind NAT devices or firewalls. All access is managed and controlled by the communication server, and client and resource level access control may be enforced. The method allows for establishing secured communication, where, network and system security may be enhanced. The clients and communication server may exchange information that is encrypted end-to-end, from one client to the other, and does not require disclosing of encryption key(s) or risking decrypted data being tempered during transmission or in transit on the communication server.

Using the present methodology allows for an improved way of establishing secured communication, where clients and communication server may exchange information that can be centrally managed. These include the security policy and access log that are required to provide simplified central security management.

In use, the present methodology provides an improved means for establishing secured communication, where access transparency (behind NAT device or firewall), ubiquitous access—from any location, to any destination, as well as behind NAT device or firewalls, may be enhanced. Using “One Port”, such as the SSL port 443, access limitations dues to “communication port” restrictions imposed by NAT/firewall, and inconsistent firewall port configurations may be removed. For example, access from behind NAT/firewall given the practical but restricted configurations, to destinations behind the NAT/firewall given the practical but restricted configurations may also be realized. Alternatively, in other embodiments the same methodology may be used with multiple ports.

By providing such improved methods for establishing secured communication, where access transparency, ubiquitous access—from any location, to any destination, for client applications may be enhanced. Applications normally not able to traverse NAT/firewall due to port restrictions, using non-secure port(s), using more than one ports; by using the “Secure Proxy” protocol, may no longer be limited to their access, and may able to provide access given the practical but restricted NAT/firewall configurations.

This also allows for greatly enhanced security and network performance. Using a secure communication port, such as the SSL port 443, may reduce network attacks. Secure ports are normally better protected. By comparison, non-secure, popular communication ports, such as the HTTP port 80, FTP port 23, are common targets of hackers and attract a large number of network attacks. Using a secure communication port and especially, a single secure port greatly reduces the chance of being bombarded with network attacks, traffic, and thus the chance of being compromised.

By using the present “Secure Proxy” protocol described herein, one or more protocols may use one communication port, where, two or more clients communicate securely via a communication server. Using this method security may be enhanced. There is no direct network access from one client to the other. All access is managed and controlled by the communication server, and client and resource level access control may be enforced.

It is also apparent that by using the “Secure Proxy” protocol herein described, security may be enhanced. End-to-end network security from access client to the target client may be enforced. This end-to-end security includes but is not limited to client authentication, and network security such as that provided by a secure network protocol like SSL. This end-to-end security allows enhanced network security for client to communication server, communication server to target client, and client to client communications.

Using the “Secure Proxy” protocol described herein, network and system performance may be enhanced. The client and communication server may exchange information that does not required decryption by the communication server. As an example, one client encrypts the data, sends it to the communication server, without decrypting the data packet, communication server sends the data packet to another client, the destination client decrypts the data packet. The performance of the communication server and the overall communication time is improved comparing the present invention to other solutions that require the additional processing on the communication server. An example to illustrate this limitation is that in a different approach, one client encrypts the data, sends it to the relay server, the relay server decrypts the data packet, examines the content of the packet to decide which target client the packet should be delivered to, encrypts the packet, the relay server then sends the data packet to another client, and the destination client decrypts the data packet. The performance of the relay server and the overall communication time is improved comparing the present invention to other solutions that require the additional processing on the relay server.

Using the “Secure Proxy” protocol of the present methodology, security management may be enhanced. The clients and communication server may exchange information that can be centrally managed. These include the security policy and access log that are required to provide simplified central security management. Another benefit of the invention is that using “One Port”, access transparency ubiquitous access—from any location, to any destination may be enhanced. Using “One Port”, such as the SSL port 443, access limitations due to “communication port” restrictions imposed by NAT/firewall, and inconsistent NAT/firewall port configurations may be removed. For example, access from behind the NAT/firewall given the practical but restricted configurations, to destinations behind the firewall/proxy given the practical but restricted configurations may also be realized. However, as noted above, multiple ports may be used if desired using the present methodology.

In practical networking environment, the restricted but practical firewall configuration is: No inbound connection allowed, and only allows outbound connection to the HTTP port 80 and the SSL port 443. A transparent communication method has to work within such constraints. Using the present method, access transparency, ubiquitous access—from any location, to any destination, for client applications may be enhanced. Applications normally not able to traverse a firewall due to port restrictions, using non-secure port(s), using more than one ports; by using the “Secure Proxy” protocol, may no longer be limited to their access, and may able to provide access given the practical but restricted firewall configurations.

Accordingly, using the preferred embodiment of the present invention, a single security port or “One Port” for all communication may allow enhanced security and network performance. Using secure communication port, such as the SSL port 443, reduces network attacks as secure ports are normally better protected. By comparison, non-secure, popular communication ports, such as the HTTP port 80, FTP port 23, are common targets of hackers and attract a large number of network attacks. Using a secure communication port and especially, a single secure port greatly reduces the chance of being bombarded with network attacks, traffic, and thus the chance of being compromised.

As is evident from FIGS. 1-8, and the above description, a wide variety of secure communication applications and systems may be envisioned from the disclosure provided. The methodology described herein is applicable in any computer system, computer network, internet and non-internet based communications, and additional advantages and modifications will readily occur to those skilled in the art. Further, the present invention may utilize any computing device and a computer-readable medium encoded with a computer program for secure communication in the communication network. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. In a computing network, a method for secure communication, comprising:
using a single communication port for secured communications between two clients, within said computing network;
requesting communication by a client for connection to a communication server;
receiving said communication request and a handshake sequence is performed between said client and said communication server;
establishing a secure connection between said client and said communication server;
requesting communication by a second client for connection to the communication server;
coordinating a handshake sequence between said second client and said communication server;
establishing a secure connection between the second client and said communication server;
coordinating a new connection between the two clients by the communication server;
coordinating a handshake sequence between the two clients by the communication server; and
establishing a secure connection between the two clients via the communication server wherein said single communication port allows access behind network securing means by establishing a secure proxy communication between said two clients by utilizing end-to-end secured data transfer.

2. The method of claim 1, wherein said single secure communication port is an SSL port, allowing for secure communication.

3. The method of claim 1, wherein said handshake sequence is SSL Private-Public Key Exchange secure message protocol.

4. The method of claim 1, wherein use of said single communication port allows access from behind network securing means including firewalls and network address translation means by establishing a secure proxy connection between said two clients using a communication server as a traffic controller.

5. The method of claim 1, wherein use of said single communication port allows access inside network securing means including firewalls and network address translation means by establishing a secure proxy connection between said two clients using said communication server to enable said secure proxy connection to securely transfer end-to end secured communications.

6. The method of claim 1, wherein use of said single communication port allows ease of management of communications by establishing a secure proxy connection utilizing end-to-end encrypted data transfer between said two clients supporting multiple application protocols.

7. The method of claim 1, wherein use of said secure proxy communication between said two clients utilizes brokering secure message protocol directly between the two clients using Private-Public Key Exchange, between the clients, end-to end, that does not disclose security keys at said communication server, allowing enhanced security and the elimination of security risks imposed by proxy implementation.

8. The method of claim 1, wherein use of said secure proxy communication between said two clients includes brokering encrypted data transfer using secure message protocol, directly between the two clients, end-to-end, that does not decrypt data transferred between clients at said communication server, allowing for enhanced security and the elimination of security risk imposed by proxy implementation.

9. The method of claim 1, wherein use of said single communication port allows eliminating any need to change configurations of network securing means including firewalls and network address translation means, by establishing a secure proxy communication between said two clients by utilizing encrypted end-to end data transfer that does not have to be decrypted at said communication server.

10. A method for secure communication in a computing device, comprising:
using a single communication port for secured communications within said computing device, for establishing secured communication between two or more clients via a communication server;
requesting communication by a client for connection to a communication server;
receiving said communication request and a handshake sequence is performed between said client and said communication server;
requesting communication by a second client for connection to the communication server;
coordinating a new connection with a second client by the communication server; and
establishing a connection between the two clients via the communication server wherein said single communication port allows access behind firewalls and network address translation means by establishing a secure proxy communication between said two clients by utilizing end-to-end encrypted data transfer.

11. A method for secure communication in a communication network utilizing a computing device and a computer-readable medium encoded with a computer program for secure communication in the communication network, comprises:
using multiple communication ports for secured communication within said communication network for establishing secured communications between two or more clients via a communication server;
requesting communication by a client for connection to a communication server;
receiving said communication request and a handshake sequence is performed between said client and said communication server;
establishing a secure connection between said client and said communication server;
requesting communication by a second client for connection to the communication server; and
establishing a connection between the two clients via the communication server wherein said multiple communication ports allow access behind firewalls and network address translation means by establishing a secure proxy communication between said two clients by utilizing end-to-end secured data transfer that does not disclose encryption keys and does not require decryption of data transfer between clients at said communication server.
